(19) United States
(12) Patent Application Publication
(10) Pub. No.: US 2018/0358656 A1
(43) Pub. Date: Dec. 13, 2018

(54) ADDITIVE FOR NON-AQUEOUS ELECTROLYTE

(71) Applicant: GM GLOBAL TECHNOLOGY OPERATIONS LLC, Detroit, MI (US)

(72) Inventor: Shawn DENG, Shanghai (CN)

(73) Assignee: GM GLOBAL TECHNOLOGY OPERATIONS LLC, Detroit, MI (US)

(21) Appl. No.: 16/061,224

(22) PCT Filed: Jan. 15, 2016
(86) PCT No.: PCT/CN2016/071015

§ 371 Date: Jun. 11, 2018

(51) Int. Cl. H01M 10/0567; H01M 10/0569; H01M 10/0568; H01M 10/0525

(52) U.S. Cl. CPC H01M 10/0567; H01M 10/0569; H01M 2300/0042; H01M 10/0525; H01M 10/0568

(57) ABSTRACT

A non-aqueous electrolyte includes a solvent, a lithium salt, and an additive selected from: formulas, and combinations thereof. R₁, R₂, and R₃ are independently selected from: a linear or branched alkyl having a formula CₙH₂ₙ₊₁ (n ranges from 1 to 20); a linear or branched alkoxyl having a formula C₂H₂ₙ₊₁O (n ranges from 1 to 20); a linear or branched either having a formula CₙH₂ₙ₊₁OCₘH₂ₘ (n and m each range from 1 to 10); phenyl; a mono-substituted phenyl with one linear or branched alkyl having a formula CₙH₂ₙ₊₁ (n ranges from 1 to 20); a di-substituted phenyl with two linear or branched alkyls, each alkyl having a formula CₙH₂ₙ₊₁ (n ranges from 1 to 20); a tri-substituted phenyl with three linear or branched alkyls, each alkyl having a formula CₙH₂ₙ₊₁ (n ranges from 1 to 20); and combinations thereof. X, Y, and Z are halides.

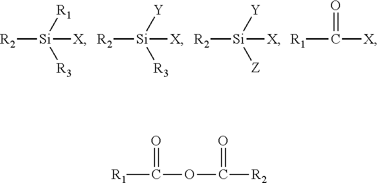

### BACKGROUND

Secondary, or rechargeable, lithium ion batteries are often used in many stationary and portable devices, such as those encountered in the consumer electronic, automobile, and aerospace industries. The lithium ion class of batteries has gained popularity for various reasons, including a relatively high energy density, a general nonappearance of any memory effect when compared with other kinds of rechargeable batteries, a relatively low internal resistance, a low self-discharge rate when not in use, and an ability to be formed into a wide variety of shapes (e.g., prismatic) and sizes so as to efficiently fill available space in electric vehicles, cellular phones, and other electronic devices. In addition, the ability of lithium ion batteries to undergo repeated power cycling over their useful lifetimes makes them an attractive and dependable power source.

### SUMMARY

A non-aqueous electrolyte includes a solvent, a lithium salt, and an additive. The additive is selected from the group consisting of:

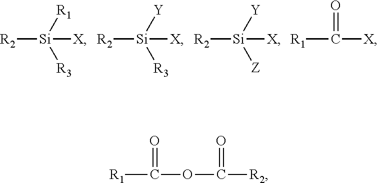

and combinations thereof. R₁, R₂, and R₃ are independently selected from the group consisting of: a linear or branched alkyl having a formula CₙH₂ₙ₊₁ (n ranges from 1 to 20); a linear or branched alkoxyl having a formula CₙH₂ₙ₊₁O (n ranges from 1 to 20); a linear or branched ether having a formula CₙH₂ₙ₊₁OCₘH₂ₘ (n and m each range from 1 to 10); phenyl; a mono-substituted phenyl with one linear or branched alkyl having a formula CₙH₂ₙ₊₁ (n ranges from 1 to 20); a di-substituted phenyl with two linear or branched alkyls, each alkyl having a formula CₙH₂ₙ₊₁ (n ranges from 1 to 20); a tri-substituted phenyl with three linear or branched alkyls, each alkyl having a formula CₙH₂ₙ₊₁ (n ranges from 1 to 20); and combinations thereof. X, Y, and Z are each a halide.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic flow diagram illustrating interaction between an additive in a non-aqueous electrolyte and a negative electrode active material in order to reduce gas production; and

FIG. 2 schematically illustrates an example of a lithium ion battery during a discharging state.

### DETAILED DESCRIPTION

Many different materials may be used to create the positive electrodes, the negative electrodes, and the electrolyte in a lithium ion battery. The positive electrode may include an electroactive material that can be intercalated with lithium ions, such as lithium-transition metal oxides or mixed oxides of the spinel type, for example LiCoO₂, LiMn₂O₄, LiNiO₂, LiNi_{(1-x-y)}CoₓM_{y}O₂ (where 0<x<1, y<1, and M may be Al, Mn, or the like), or lithium iron phosphates. The electrolyte typically contains one or more lithium salts, which may be dissolved and ionized in a non-aqueous solvent. The negative electrode may include a lithium insertion material or an alloy host material. Example electroactive materials for forming the negative electrode include lithium-graphite intercalation compounds, lithium-silicon intercalation compounds, lithium alloys and lithium titanate (Li₄₊ₓTi₅O₁₂, where 0≤x≤3, such as Li₄Ti₅O₁₂ (LTO), which may be a nano-structured LTO. Contact of the negative and positive electrode materials with the electrolyte can create an electrical potential between the electrodes. When electron current is generated in an external circuit between the electrodes, the potential is sustained by electrochemical reactions within the cells of the battery.

LTO is a particularly desirable negative electrode material. Many Li-ion batteries can suffer from capacity fade attributable to many factors, including the formation of a passive film known as solid electrolyte interphase (SEI) layer over the surface of the negative electrode (anode), which is often generated by reaction products of the negative electrode material, electrolyte reduction, and/or lithium ion reduction. The SEI layer formation plays a significant role in determining electrode behavior and properties including cycle life, irreversible capacity loss, high current efficiency, and high rate capabilities, particularly advantageous for power battery and start-stop battery use. LTO has a high cut voltage (e.g., cut-off potentials relative to a lithium metal reference potential) that desirably minimizes or avoids SEI formation, and is a zero-strain material having minimal volumetric change during lithium insertion and deinsertion, which enables long term cycling stability, high current efficiency, and high rate capabilities. Such long term cycling stability, high current efficiency, and high rate capabilities are particularly advantageous for power battery and start-stop battery use.

LTO is a promising negative electrode material for high power lithium ion batteries, providing extremely long life and exceptional tolerance to overcharge and thermal abuse. However, when used with certain positive electrode materials and electrolytes, LTO may potentially have certain disadvantages. For example, it has been observed that Li₄₊ₓTi₅O₁₂ can generate significant quantities of gas, which mainly consists of hydrogen, within a battery cell especially at elevated temperature conditions under charging state. Such gas formation can make it an undesirable choice for commercial use.

Examples of the non-aqueous electrolyte disclosed herein reduce gassing and improve the calendar life of the lithium ion battery (which includes an LTO negative electrode) in which the non-aqueous electrolyte is utilized. The electrolyte includes an additive (also referred to herein as the subject additive) that is capable of reacting with hydroxyl groups on the surface of the negative electrode active material. The reaction between the additive and the surface hydroxyl groups attaches the additive to the negative electrode active material. The attachment of the additive to the negative electrode active material reduces or prevents the reduction of the surface hydroxyl groups, thus reducing or preventing the release of hydrogen gas resulting from the reduction. In the meantime, the additive reduces or prevents the chemical decomposition of the electrolyte solvents that re-generates hydroxyl groups, which leads to improved battery performance and calendar life.

The non-aqueous electrolyte includes a solvent, a lithium salt, and the additive.

The solvent is a non-aqueous, organic solvent. Examples of the solvent include cyclic carbonates (ethylene carbonate (EC), propylene carbonate (PC), butylene carbonate, fluoroethylene carbonate), linear carbonates (dimethyl carbonate, diethyl carbonate, ethylmethyl carbonate (EMC)), aliphatic carboxylic esters (methyl butyrate, methyl formate, methyl acetate, methyl propionate), γ-lactones (γ-butyrolactone, γ-valerolactone), chain structure ethers (1,2-dimethoxyethane (DME), 1,2-diethoxyethane, ethoxymethoxyethane), cyclic ethers (tetrahydrofuran, 2-methyltetrahydrofuran), 1,3-dioxolane (DOL or DIOX), tetraethylene glycol dimethyl ether (TEGDME), polyethylene glycol dimethyl ether (PEGDME), and mixtures thereof. An example of a suitable solvent mixture includes propylene carbonate, ethylene carbonate, dimethyl carbonate, diethyl carbonate, and methyl butyrate (e.g., 15:5:5:5:70 v/v). Another example of a suitable solvent mixture is propylene carbonate, ethyl methyl carbonate, and methyl butyrate (e.g., 1:3:1, v/v).

Any suitable lithium salt may be dissolved in the non-aqueous, organic solvent to form the non-aqueous electrolyte. Examples of the lithium salts include LiClO₄, LiAlCl₄, LiI, LiBr, LiSCN, LiBF₄, LiB(C₆H₅)₄, LiSO₃CF₃, lithium bis(trifluoromethylsulfonyl)imide (LiN(CF₃SO₂)₂ or LiTFSI), LiN(FSO₂)₂ (LiFSI), LiAsF₆, LiPF₆, LiB(C₂O₄)₂ (LiBOB), LiBF₂(C₂O₄) (LiODFB), LiPF₃(C₂F₅)₃ (LiFAP), LiPF₄(C₂O₄) (LiFOP), LiPF₄(CF₃)₂, LiPF₃(CF₃)₃, LiNO₃, and combinations thereof. In an example, the concentration of the lithium salt in the non-aqueous electrolyte is about 1 M. In an example, the concentration of the lithium salt in the non-aqueous electrolyte ranges from about 0.5 M to about 1.5 M.

The non-aqueous electrolyte also includes the additive. This additive may be a silicon-based additive or a carbonyl-based additive (see representative structures below), which includes group(s) that can react with surface hydroxyl group(s) of the active material present in the negative electrode of the lithium ion battery incorporating the non-aqueous electrolyte. Examples of the additive include:

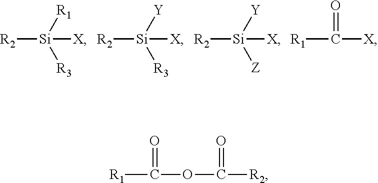

and combinations thereof. In each of these structures, R₁, R₂, and R₃ are independently selected from the group consisting of a linear or branched alkyl having the formula CₙH₂ₙ₊₁, wherein n ranges from 1 to 20; a linear or branched alkoxyl having the formula CₙH₂ₙ₊₁O, wherein n ranges from 1 to 20; a linear or branched ether having the formula CₙH₂ₙ₊₁OCₘH₂ₘ, wherein n ranges from 1 to 10 and m ranges from 1 to 10; phenyl; a mono-substituted phenyl with one linear or branched alkyl having the formula CₙH₂ₙ₊₁, wherein n ranges from 1 to 20; a di-substituted phenyl with two linear or branched alkyls, each alkyl having the formula CₙH₂ₙ₊₁, wherein n ranges from 1 to 20; a tri-substituted phenyl with three linear or branched alkyls, each alkyl having the formula CₙH₂ₙ₊₁, wherein n ranges from 1 to 20; and combinations thereof. Also, in some of these structures, X, Y, and/or Z are/is a halide (e.g., fluorine (F), chlorine (Cl), bromine (Br), or iodine (I)).

One specific example of the additive has the structure

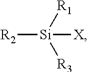

where R₁, R₂, and R₃ are each C₂H₅, and X is chlorine. This additive is known as triethyl chlorosilane or chlorotriethylsilane or TECS.

The additive is included in the non-aqueous electrolyte in an amount ranging from about 0.01 wt. % to about 10 wt. % of a total weight of the electrolyte. As an example, about 2 wt. % of the additive is included in the non-aqueous electrolyte.

As mentioned above, the additive includes group(s) that can react with surface hydroxyl group(s) of the active material present in the negative electrode of the lithium ion battery incorporating the non-aqueous electrolyte. In some examples, the halide reacts with the surface hydroxyl group(s) of the active material, and in other examples, the anhydride reacts with the surface hydroxyl group(s) of the active material.

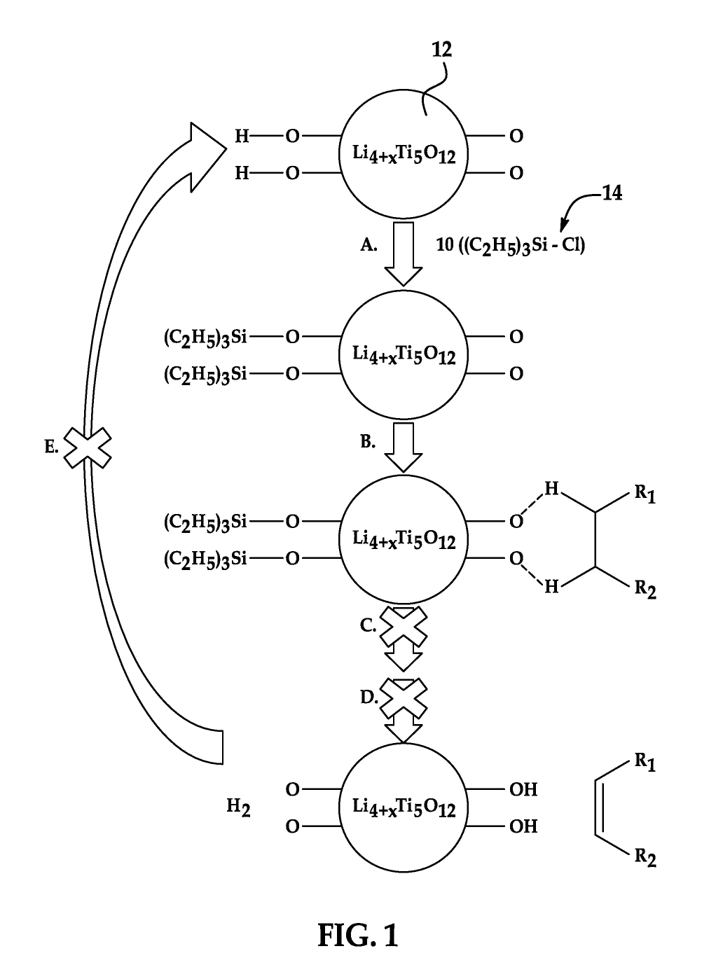

A schematic illustration of the interaction between the additive and the negative electrode active material is depicted in FIG. 1. As illustrated, the negative electrode active material 12 is lithium titanate (Li₄₊ₓTi₅O₁₂, where 0≤x≤3) having some surface hydroxyl (OH) groups. At reference character A in FIG. 1, the negative electrode active material 12 is exposed to the non-aqueous electrolyte 10, which includes the additive 14. In the example shown in FIG. 1, the additive 14 is triethyl chlorosilane. Without being bound to any theory, it is believed that the chlorine atom of the additive 14 (or other halide or anhydride group of another additive 14) reacts with the OH group of the active material 12, such that the chlorine group leaves (e.g., in the form of HCl) and the remainder of the additive 14 bonds to the oxygen atom on the surface of the active material 12.

Reference character B in FIG. 1 illustrates the adsorption of the solvent of the non-aqueous electrolyte 10 on the surface of the active material 12. The solvent is absorbed onto the LTO surface due to interaction similar to hydrogen bonding.

As illustrated in FIG. 1 after reference character B, the surface oxygen and hydroxyl groups are bonded to the solvent and additive 14, respectively. As such, the hydroxyl groups are not free to undergo reduction, which would otherwise release hydrogen gas and form oxygen atoms on the surface of the active material 12 (reference character C). Additionally, the electrolyte solvents are not free to undergo chemical decomposition, which would otherwise regenerate hydroxyl groups on the surface of the active material 12 (reference character D). The regeneration of hydroxyl groups can lead to a catalytic cycle. Since oxygen atoms and hydroxyl groups are not regenerated at the surface of the active material, subsequent cycles (reference character E) of gas generation and electrolyte solvent decomposition are avoided. In other words, the additive disclosed herein breaks the catalytic cycle that results in the formation of hydrogen gas and decomposition of the electrolyte.

A specific example of the non-aqueous electrolyte including the additive 14 shown in FIG. 1, namely triethyl chlorosilane, also includes a mixture of propylene carbonate, ethylene carbonate, dimethyl carbonate, diethyl carbonate, and methyl butyrate as the solvent and LiPF₆ as the lithium salt.

The non-aqueous electrolyte may also include a number of other additives, such as solvents and/or salts that are minor components of the electrolyte. Examples of these other additives include vinylene carbonate (VC), vinyl ethylene carbonate (VEC), fluoroethylene carbonate (FEC), 1,3-propane sultone (PS), methylene methane disulfonate, etc. While some examples have been given herein, it is to be understood that many other additives could be used as long as they don't react with the subject additive. When included, these other additives may make up from about 0.01 wt. % to about 15 wt. % of the total weight of the non-aqueous electrolyte.

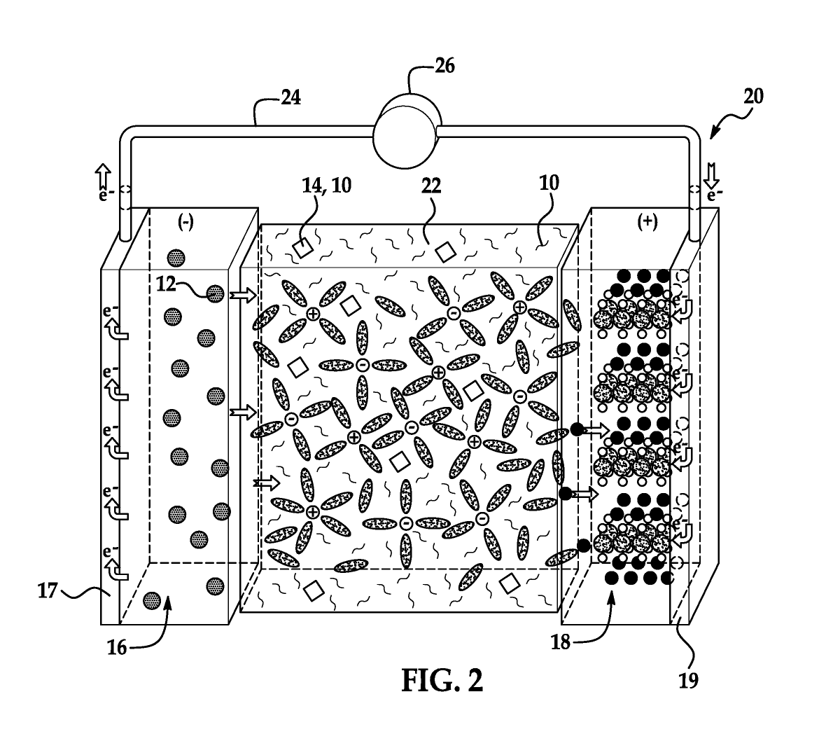

As mentioned above, the non-aqueous electrolyte 10 may be used in a lithium ion battery, which includes a negative electrode with an active material 12 that has hydroxyl groups on the surface thereof. An example of the lithium ion battery 20 is shown in FIG. 2.

As mentioned above, the negative electrode 16 includes an active material 12 that has hydroxyl groups on the surface thereof. The active material 12 may be lithium titanate (Li₄₊ₓTi₅O₁₂), where x ranges from 0 to 3 depending on the state of charge (SOC). The lithium titanate may be present in an amount ranging from about 85 weight percent (wt. %) to about 95 wt. % based on a total weight of the negative electrode 16. The primary particle size of the lithium titanate is less than 2 μm. The particle size distribution of the lithium titanate has D50 of less than 10 μm and D 95 of less than 30 μm. In other words, 50% of the lithium titanate particles have a size smaller than 10 μm, and 95% of the lithium titanate particles have a size smaller than 30 μm.

The negative electrode 16 may also include a binder present in an amount ranging from about 1 wt. % to about 8 wt. % based on the total weight of the negative electrode 16. In an example, the binder is present in an amount ranging from 2 wt. % to about 8 wt. % based on the total weight of the negative electrode 12. The binder may be polyvinylidene fluoride (PVDF), polytetrafluoroethylene (PTFE), polyethylene oxide (PEO), ethylene propylene diene monomer (EPDM) rubber, carboxymethyl cellulose (CMC), styrene-butadiene rubber (SBR), polyacrylic acid (PAA), cross-linked polyacrylic acid-polyethylenimine, lithium polyacrylate (LiPAA), cross-linked lithiated polyacrylate, polyimide, carboxymethylcellulose sodium and polymerized styrene butadiene rubber (CMC+SBR), LA133, or LA132 or combinations thereof. LA133 is an aqueous binder that is a water dispersion of acrylonitrile multi-copolymer and LA132 is an aqueous binder, which is believed to be a triblock copolymer of acrylamide, lithium methacrylate, and acrylonitrile; both of these acrylonitrile copolymers are available from Chengdu Indigo Power Sources Co., Ltd., Sichuan, P.R.C. Other suitable binders may include polyvinyl alcohol (PVA), sodium alginate, or other water-soluble binders.

The negative electrode 16 may also include a conductive filler present in an amount ranging from about 1 wt. % to about 15 wt. % based on the total weight of the negative electrode 16. The conductive filler may be a conductive carbon material. The conductive carbon material may be a high surface area carbon, such as acetylene black (e.g., SUPER P® conductive carbon black from Timcal Graphite & Carbon (Bodio, Switzerland)), graphite, vapor-grown carbon fiber (VGCF), and/or carbon nanotubes. Commercial forms of graphite that may be used are available from, for example, Timcal Graphite & Carbon, Lonza Group (Basel, Switzerland), or Superior Graphite (Chicago, Ill.). One specific example is TIMREX® KS6 (primary synthetic graphite from Timcal Graphite & Carbon. The vapor-grown carbon fiber may be in the form of fibers having a diameter ranging from about 100 nm to about 200 nm, a length ranging from about 3 μm to about 10 μm, and a BET surface area ranging from about 10 m²/g to about 20 m²/g. The carbon nanotubes may have a diameter ranging from about 8 nm to about 25 nm and a length ranging from about 1 μm to about 20 μm. Any one or more of the conductive fillers may be included to ensure electron conduction between the active material 12 and a negative-side current collector 17 (copper or another suitable material functioning as the negative terminal of the battery 20).

The lithium ion battery 20 also includes the positive electrode 18. The positive electrode 18 includes any lithium-based active material that can sufficiently undergo lithium insertion and deinsertion while aluminum or another suitable current collector 19 is functioning as the positive terminal of the lithium ion battery 20. One common class of known lithium-based active materials suitable for the positive electrode 18 includes layered lithium transition metal oxides. For example, the lithium-based active material may be spinel lithium manganese oxide (LiMn₂O₄), lithium cobalt oxide (LiCoO₂), a manganese-nickel oxide spinel [Li(Mn_{1.5}Ni_{0.5})O₂], a layered lithium nickel manganese cobalt oxide (having a general formula of xLi₂MnO₃.(1-x)LiMO₂, where M is composed of any ratio of Ni, Mn and/or Co). A specific example of the layered lithium nickel manganese cobalt oxide includes (xLi₂MnO₃.(1-x)Li(Ni_{1/3} Mn_{1/3}Co_{1/3})O₂). Other suitable lithium-based active materials include Li(Ni_{1/3}Mn_{1/3}Co_{1/3})O₂, Li_{x+y}Mn_{2-y}O₄ (LMO, 0<x<1 and 0<y<0.1), or a lithium iron polyanion oxide, such as lithium iron phosphate (LiFePO₄) or lithium iron fluorophosphate (Li₂FePO₄F), or a lithium rich layer-structure. Still other lithium based active materials may also be utilized, such as LiNi₁₊ₓCo_{1-y}M_{x+y}O₂ or LiMn_{1.5-x}Ni_{0.5-y}M_{x+y}O₄ (M is composed of any ratio of Al, Ti, Cr, and/or Mg), stabilized lithium manganese oxide spinel (LiₓMn_{2-y}M_{y}O₄, where M is composed of any ratio of Al, Ti, Cr, and/or Mg), lithium nickel cobalt aluminum oxide (e.g., LiNi_{0.8}Co_{0.15}Al_{0.05}O₂ or NCA), aluminum stabilized lithium manganese oxide spinel (e.g., LiₓAl_{0.05}Mn_{0.95}O₂), lithium vanadium oxide (LiV₂O₅), Li₂MSiO₄ (where M is composed of any ratio of Co, Fe, and/or Mn), and any other high energy nickel-manganese-cobalt material (HE-NMC, NMC or LiNiMnCoO₂). By “any ratio” it is meant that any element may be present in any amount. So, in some examples, M could be Al, with or without Cr, Ti, and/or Mg, or any other combination of the listed elements. In another example, anion substitutions may be made in the lattice of any example of the lithium transition metal based active material to stabilize the crystal structure. For example, any O atom may be substituted with an F atom. Still other examples of suitable active materials for the positive electrode include V₂O₅ and MnO₂.

The positive electrode 18 may also include any of the previously mentioned binder(s) and/or conductive filler(s). An example of the composition of the positive electrode 18 includes about 85 wt. % to about 95 wt. % of the active material, from about 1 wt. % to about 15 wt. % of the binder, and from about 1 wt. % to about 15 wt. % of the conductive filler.

The lithium ion battery 20 also includes the porous polymer separator 22 positioned between the positive and negative electrodes 18, 16. The porous separator 22 operates as an electrical insulator (preventing the occurrence of a short), a mechanical support, and a barrier to prevent physical contact between the two electrodes 18, 16. The porous separator 22 also ensures passage of lithium ions (identified by the Li⁺) through the non-aqueous electrolyte 10 filling its pores.

The porous polymer separator 22 may be formed, e.g., from a polyolefin. The polyolefin may be a homopolymer (derived from a single monomer constituent) or a heteropolymer (derived from more than one monomer constituent), and may be either linear or branched. If a heteropolymer derived from two monomer constituents is employed, the polyolefin may assume any copolymer chain arrangement including those of a block copolymer or a random copolymer. The same holds true if the polyolefin is a heteropolymer derived from more than two monomer constituents. As examples, the polyolefin may be polyethylene (PE), polypropylene (PP), a blend of PE and PP, or multi-layered structured porous films of PE and/or PP. Commercially available porous separators 22 include single layer polypropylene membranes, such as CELGARD 2400 and CELGARD 2500 from Celgard, LLC (Charlotte, N.C.). It is to be understood that the porous separator 22 may be coated or treated, or uncoated or untreated. For example, the porous separator 22 may or may not be coated or include any surfactant treatment thereon.

In other examples, the porous separator 22 may be formed from another polymer chosen from polyethylene terephthalate (PET), polyvinylidene fluoride (PVdF), polyamides (Nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polyolefin copolymers, acrylonitrile-butadiene styrene copolymers (ABS), polystyrene copolymers, polymethylmethacrylate (PMMA), polyvinyl chloride (PVC), polysiloxane polymers (such as polydimethylsiloxane (PDMS)), polybenzimidazole (PBI), polybenzoxazole (PBO), polyphenylenes (e.g., PARMAX™ (Mississippi Polymer Technologies, Inc., Bay Saint Louis, Miss.)), polyarylene ether ketones, polyperfluorocyclobutanes, polytetrafluoroethylene (PTFE), polyvinylidene fluoride copolymers and terpolymers, polyvinylidene chloride, polyvinylfluoride, liquid crystalline polymers (e.g., VECTRAN™ (Hoechst AG, Germany) and ZENITE® (DuPont, Wilmington, Del.)), polyaramides, polyphenylene oxide, and/or combinations thereof. It is believed that another example of a liquid crystalline polymer that may be used for the porous separator 22 is poly(p-hydroxybenzoic acid). In yet another example, the porous separator 22 may be chosen from a combination of the polyolefin (such as PE and/or PP) and one or more of the other polymers listed above.

The porous separator 22 may be a single layer or may be a multi-layer (e.g., bilayer, trilayer, etc.) laminate fabricated from either a dry or wet process.

The non-aqueous electrolyte 10 of the lithium ion battery 20 may be any of the examples previously described, and includes the solvent, the lithium salt, and the additive 14. Each of the negative electrode 16, the porous polymer separator 22, and the positive electrode 18 may be soaked in the non-aqueous electrolyte 10.

As shown in FIG. 2, the fully assembled lithium ion battery 20 may also include an external circuit 24 that connects the current collectors 16, 18. The battery 20 may also support the load device 26 that can be operatively connected to the external circuit 24. The load device 26 may receive a feed of electrical energy from the electric current passing through the external circuit 24 when the battery 20 is discharging. While the load device 26 may be any number of known electrically-powered devices, a few specific examples of a power-consuming load device include an electric motor for a hybrid vehicle or an all-electrical vehicle, a laptop computer, a cellular phone, and a cordless power tool. The load device 26 may also, however, be a power-generating apparatus that charges the battery 20 for purposes of storing energy. For instance, the tendency of windmills and solar panels to variably and/or intermittently generate electricity often results in a need to store surplus energy for later use.

At the beginning of a discharge, the negative electrode 16 of the battery 20 contains a high concentration of inserted lithium while the positive electrode 18 is relatively depleted. When the negative electrode 16 contains a sufficiently higher relative quantity of inserted lithium, the battery 20 can generate a beneficial electric current by way of reversible electrochemical reactions that occur when the external circuit 24 is closed to connect the negative electrode 12 and the positive electrode 18. The establishment of the closed external circuit under such circumstances causes the extraction of inserted lithium from the negative electrode 16. The extracted lithium atoms are split into lithium ions (identified by the black dots and by the open circles having a (+) charge) and electrons (e) as they leave the insertion host (i.e., negative electrode 16).

The chemical potential difference between the electrodes 16, 18 drives the electrons (e⁻) produced by the oxidation of inserted lithium at the negative electrode 16 through the external circuit 24 towards the positive electrode 18. The lithium ions are concurrently carried by the electrolyte through the porous polymer separator 22 towards the positive electrode 18. The different voltage potential windows disclosed herein may be used to control the amount of lithium that is transported during cycling.

The electrons (e) flowing through the external circuit 24 and the lithium ions migrating across the porous polymer separator 22 in the electrolyte eventually reconcile and form inserted lithium at the positive electrode 18. The electric current passing through the external circuit 24 can be harnessed and directed through the load device 26 until the level of lithium in the negative electrode 16 falls below a workable level or the need for electrical energy ceases.

The battery 20 may be recharged after a partial or full discharge of its available capacity. To charge the battery 20, an external battery charger is connected to the positive and the negative electrodes 16, 18, to drive the reverse of battery discharge electrochemical reactions. During recharging, the electrons (e) flow back toward the negative electrode 16 through the external circuit 24, and the lithium ions are carried by the electrolyte 10 across the porous polymer separator 22 back toward the negative electrode 16. The electrons (e) and the lithium ions are reunited at the negative electrode 16, thus replenishing it with inserted lithium for consumption during the next battery discharge cycle.

The external battery charger that may be used to charge the battery 20 may vary depending on the size, construction, and particular end-use of the battery 20. Some suitable external battery chargers include a battery charger plugged into an AC wall outlet and a motor vehicle alternator.

To further illustrate the present disclosure, an example is given herein. It is to be understood that this example is provided for illustrative purposes and is not to be construed as limiting the scope of the present disclosure.

### EXAMPLE

Five single layer pouch cells were prepared, each with a lithium titanate (LTO) negative electrode, a lithium manganese oxide (LMO) positive electrode, PVDF as the binder, SP, KS6, and VGCF as conductive fillers. Two comparative example pouch cells (C1, C2) included an electrolyte of 1.0 M LiPF₆ in a solvent mixture including propylene carbonate, ethylene carbonate, dimethyl carbonate, diethyl carbonate, and methyl butyrate (e.g., 15:5:5:5:70 v/v). Three example pouch cells (E1, E2, and E3) included the same electrolyte, and also included 2 wt. % of triethyl chlorosilane as the additive. In each of the cells, the separator was CELGARD® 2325.

The cells were tested under three different protocols.

The first protocol involved a formation step. In this step, a constant current and constant voltage (CCCV) protocol was applied. The cells were first charged at 0.05 C rate to 2.7 V, and then the cell voltage was kept constant until the current dropped to 0.01 C. Then, the cells were discharged at 0.1 C rate to the cutoff voltage of 1.5 V. The cells went through 3 such formation cycles before continuing into the second protocol.

The second protocol involved an aging step. In this step, the cells were charged at 0.2 C rate until 100% State of Charge (SOC), and then rested at 70° C. for 7 days. Following the aging process, the cells were degassed by cutting down the extra gas bag. After 24 hours of open-circuit resting, the cells were charged and discharged for 3 cycles at 1 C rate. In the cell charge/discharge cycling test, a similar CCCV protocol was followed. At 25° C., the cells were first charged at 1 C rate to 2.7 V, followed with constant voltage control until the current dropped to 0.05 C. Then, the cells were subsequently discharged at 1 C rate to the cutoff voltage of 1.5 V.

The third protocol involved a final aging step. In this step, the cells were charged at 0.2 C rate until 100% State of Charge (SOC), and then rested at 70° C. for 7 days. After 24 hours of open-circuit resting at 25° C., the cells were charged and discharged for 3 cycles at 1 C rate. In the cell charge/discharge cycling test, a similar CCCV protocol was followed.

The capacity of the comparative and example cells was measured for each of the cells during each of the tests. The capacity of the comparative and example cells after the second protocol test was performed are shown in Table 1. The DC resistance (DCR) of the comparative and example cells was determined after the second protocol test, and these results are also shown in Table 1. Table 1 also illustrates the capacity remaining rate, average capacity, and DCR of the comparative and example cells after the third protocol test was performed, and the gas increase rate of the example cells as compared with the comparative cells after the third protocol test.

TABLE 1

| | Capacity | DCR after | Capacity | Average | | Gas |
|---|---|---|---|---|---|---|
| | after 2^{nd} | 2^{nd} Protocol | remaining rate | Capacity after | DCR after | increase |
| | Protocol Test | Test | after final aging | final aging | final aging | rate |
| Cell | (mAh) | (Ω) | (%) | (mAh) | (Ω) | (%) |
| C1 | 12.1 | 0.7517 | 0.0 | 11.5 | 1.1321 | 0 |
| C2 | 12.8 | 0.7720 | 0.0 | | 1.8901 | |
| E1 | 13.6 | 0.6328 | 24.3 | 11.1 | 1.1016 | −47.6 |
| E2 | 13.1 | 0.6490 | 20.2 | | 1.0877 | |
| E3 | 12.9 | 0.8087 | 43.5 | | 1.0242 | |

As depicted from the results in Table 1, the additive in the electrolyte of the example cells E1, E2, and E2 reduced the gassing by 50% (as compared with cells C1 and C2, which were similar but had no additive) and also improved the calendar life of the example cells.

It is to be understood that the ranges provided herein include the stated range and any value or sub-range within the stated range. For example, a range from about 0.01 wt. % to about 10 wt. % should be interpreted to include not only the explicitly recited limits of about 0.01 wt. % to about 10 wt. %, but also to include individual values, such as 0.1 wt. %, 3.5 wt. %, 7 wt. %, etc., and sub-ranges, such as from about 0.5 wt. % to about 9 wt. %, etc. Furthermore, when “about” is utilized to describe a value, this is meant to encompass minor variations (up to ±10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A non-aqueous electrolyte, comprising:
a solvent;
a lithium salt; and
an additive selected from the group consisting of 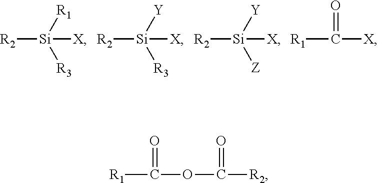
and combinations thereof;
wherein:
R₁, R₂, and R₃ are independently selected from the group consisting of a linear or branched alkyl having a formula CₙH₂ₙ₊₁, wherein n ranges from 1 to 20; a linear or branched alkoxyl having a formula CₙH₂ₙ₊₁O, wherein n ranges from 1 to 20; a linear or branched ether having a formula CₙH₂ₙ₊₁OCₘH₂ₘ, wherein n ranges from 1 to 10 and m ranges from 1 to 10; phenyl; a mono-substituted phenyl with one linear or branched alkyl having a formula CₙH₂ₙ₊₁, wherein n ranges from 1 to 20; a di-substituted phenyl with two linear or branched alkyls, each alkyl having a formula CₙH₂ₙ₊₁, wherein n ranges from 1 to 20; a tri-substituted phenyl with three linear or branched alkyls, each alkyl having a formula CₙH₂ₙ₊₁, wherein n ranges from 1 to 20; and combinations thereof; and
X, Y, and Z are each a halide.

2. The non-aqueous electrolyte as defined in claim 1 wherein the halide is selected from the group consisting of fluorine, chlorine, bromine, and iodine.

3. The non-aqueous electrolyte as defined in claim 1, wherein the additive is 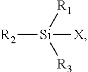
R₁, R₂, and R₃ are each C₂H₅, and X is chlorine.

4. The non-aqueous electrolyte as defined in claim 3 wherein:
the solvent is a mixture of propylene carbonate, ethylene carbonate, dimethyl carbonate, diethyl carbonate, and methyl butyrate; and
the lithium salt is LiPF₆.

5. The non-aqueous electrolyte as defined in claim 1 wherein the additive is present in an amount ranging from about 0.01 wt. % to about 10 wt. % of a total weight of the non-aqueous electrolyte.

6. The non-aqueous electrolyte as defined in claim 1 wherein:
the solvent is selected from the group consisting of ethylene carbonate, propylene carbonate, butylene carbonate, fluoroethylene carbonate, dimethyl carbonate, diethyl carbonate, ethylmethyl carbonate, methyl butyrate, methyl formate, methyl acetate, methyl propionate, γ-butyrolactone, γ-valerolactone, 1,2-dimethoxyethane, 1,2-diethoxyethane, ethoxymethoxyethane, tetrahydrofuran, 2-methyltetrahydrofuran, 1,3-dioxolane, tetraethylene glycol dimethyl ether, polyethylene glycol dimethyl ether, and mixtures thereof; and
the lithium salt is selected from the group consisting of lithium bis(trifluoromethylsulfonyl)imide (LiN(CF₃SO₂)₂ or LiTFSI), LiNO₃, LiPF₆, LiBF₄, LiI, LiBr, LiSCN, LiClO₄, LiAlCl₄, LiB(C₂O₄)₂ (LiBOB), LiB(C₆H₅)₄, LiBF₂(C₂O₄) (LiODFB), LiN(SO₂F)₂ (LiFSI), LiPF₃(C₂F₅)₃ (LiFAP), LiPF₄(CF₃)₂, LiPF₄(C₂O₄) (LiFOP), LiPF₃(CF₃)₃, LiSO₃CF₃, LiAsF₆, and combinations thereof.

7. The non-aqueous electrolyte as defined in claim 1, further comprising another additive selected from the group consisting of vinylene carbonate, vinyl ethylene carbonate, fluoro ethylene carbonate, 1,3-propane sultone, methylene methane disulfonate), and combinations thereof.

8. A lithium ion battery, comprising:
a positive electrode;
a negative electrode including lithium titanate;
a separator positioned between the positive electrode and the negative electrode; and
a non-aqueous electrolyte, including:
a solvent;
a lithium salt; and
an additive selected from the group consisting of 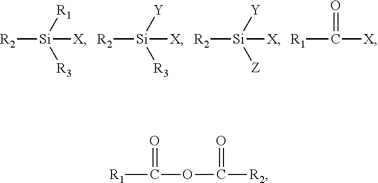
and combinations thereof;
wherein:
R₁, R₂, and R₃ are independently selected from the group consisting of a linear or branched alkyl having a formula CₙH₂ₙ₊₁, wherein n ranges from 1 to 20; a linear or branched alkoxyl having a formula CₙH₂ₙ₊₁O, wherein n ranges from 1 to 20; a linear or branched ether having a formula CₙH₂ₙ₊₁OCₘH₂ₘ, wherein n ranges from 1 to 10 and m ranges from 1 to 10; phenyl; a mono-substituted phenyl with one linear or branched alkyl having a formula CₙH₂ₙ₊₁, wherein n ranges from 1 to 20; a di-substituted phenyl with two linear or branched alkyls, each alkyl having a formula CₙH₂ₙ₊₁, wherein n ranges from 1 to 20; a tri-substituted phenyl with three linear or branched alkyls, each alkyl having a formula CₙH₂ₙ₊₁, wherein n ranges from 1 to 20; and combinations thereof; and
X, Y, and Z are each selected from the group consisting of fluorine, chlorine, bromine, and iodine.

9. The lithium ion battery as defined in claim 8 wherein the non-aqueous electrolyte further comprises another additive selected from the group consisting of vinylene carbonate, vinyl ethylene carbonate, fluoro ethylene carbonate, 1,3-propane sultone, methylene methane disulfonate), and combinations thereof.

10. The lithium ion battery as defined in claim 8, wherein:
the additive is 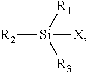
R₁, R₂, and R₃ are each C₂H₅, and X is chlorine;
the solvent is a mixture of propylene carbonate, ethylene carbonate, dimethyl carbonate, diethyl carbonate, and methyl butyrate; and
the lithium salt is LiPF₆.

11. The lithium ion battery as defined in claim 8 wherein the additive is present in an amount ranging from about 0.01 wt. % to about 10 wt. % of a total weight of the non-aqueous electrolyte.

12. The lithium ion battery as defined in claim 11 wherein:
the solvent is selected from the group consisting of ethylene carbonate, propylene carbonate, butylene carbonate, fluoroethylene carbonate, dimethyl carbonate, diethyl carbonate, ethylmethyl carbonate, methyl butyrate, methyl formate, methyl acetate, methyl propionate, γ-butyrolactone, γ-valerolactone, 1,2-dimethoxyethane, 1,2-diethoxyethane, ethoxymethoxyethane, tetrahydrofuran, 2-methyltetrahydrofuran, 1,3-dioxolane, tetraethylene glycol dimethyl ether, polyethylene glycol dimethyl ether, and mixtures thereof; and
the lithium salt is selected from the group consisting of lithium bis(trifluoromethylsulfonyl)imide (LiN(CF₃SO₂)₂ or LiTFSI), LiNO₃, LiPF₆, LiBF₄, LiI, LiBr, LiSCN, LiClO₄, LiAlCl₄, LiB(C₂O₄)₂ (LiBOB), LiB(C₆H₅)₄, LiBF₂(C₂O₄) (LiODFB), LiN(SO₂F)₂ (LiFSI), LiPF₃(C₂F₅)₃ (LiFAP), LiPF₄(CF₃)₂, LiPF₄(C₂O₄) (LiFOP), LiPF₃(CF₃)₃, LiSO₃CF₃, LiAsF₆, and combinations thereof.

13. A method, comprising:
incorporating an additive into a non-aqueous electrolyte including a solvent and a lithium salt, the additive being selected from the group consisting of 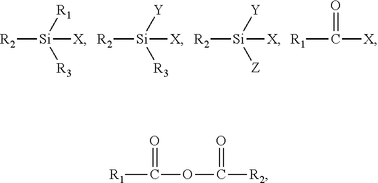
and combinations thereof;
wherein:
R₁, R₂, and R₃ are independently selected from the group consisting of a linear or branched alkyl having a formula CₙH₂ₙ₊₁, wherein n ranges from 1 to 20; a linear or branched alkoxyl having a formula CₙH₂ₙ₊₁O, wherein n ranges from 1 to 20; a linear or branched ether having a formula CₙH₂ₙ₊₁OCₘH₂ₘ, wherein n ranges from 1 to 10 and m ranges from 1 to 10; phenyl; a mono-substituted phenyl with one linear or branched alkyl having a formula CₙH₂ₙ₊₁, wherein n ranges from 1 to 20; a di-substituted phenyl with two linear or branched alkyls, each alkyl having a formula CₙH₂ₙ₊₁, wherein n ranges from 1 to 20; a tri-substituted phenyl with three linear or branched alkyls, each alkyl having a formula CₙH₂ₙ₊₁, wherein n ranges from 1 to 20; and combinations thereof; and
X, Y, and Z are each a halide.

14. The method as defined in claim 13, further comprising reducing gas production in, and improving a calendar life of a lithium ion battery including a lithium titanate negative electrode by:
incorporating the non-aqueous electrolyte into the lithium ion battery; and
cycling the lithium ion battery.

15. The method as defined in claim 13 wherein:
the additive is present in an amount ranging from about 0.01 wt. % to about 10 wt. % of a total weight of the non-aqueous electrolyte;
X, Y, and Z are each selected from the group consisting of fluorine, chlorine, bromine, and iodine;
the solvent is selected from the group consisting of ethylene carbonate, propylene carbonate, butylene carbonate, fluoroethylene carbonate, dimethyl carbonate, diethyl carbonate, ethylmethyl carbonate, methyl butyrate, methyl formate, methyl acetate, methyl propionate, γ-butyrolactone, γ-valerolactone, 1,2-dimethoxyethane, 1,2-diethoxyethane, ethoxymethoxyethane, tetrahydrofuran, 2-methyltetrahydrofuran, 1,3-dioxolane, tetraethylene glycol dimethyl ether, polyethylene glycol dimethyl ether, and mixtures thereof; and
the lithium salt is selected from the group consisting of lithium bis(trifluoromethylsulfonyl)imide (LiN(CF₃SO₂)₂ or LiTFSI), LiNO₃, LiPF₆, LiBF₄, LiI, LiBr, LiSCN, LiClO₄, LiAlCl₄, LiB(C₂O₄)₂ (LiBOB), LiB(C₆H₅)₄, LiBF₂(C₂O₄) (LiODFB), LiN(SO₂F)₂ (LiFSI), LiPF₃(C₂F₅)₃ (LiFAP), LiPF₄(CF₃)₂, LiPF₄(C₂O₄) (LiFOP), LiPF₃(CF₃)₃, LiSO₃CF₃, LiAsF₆, and combinations thereof.
